(19) United States
(12) Patent Application Publication
(10) Pub. No.: US 2016/0199989 A1
(43) Pub. Date: Jul. 14, 2016

(54) MAGNETIC HAIR CLIPPER GUARD HOLDER

(71) Applicants: Latroy K. Randell, Deerfield Beach, FL (US); Tamicka B. Randell, Deerfield Beach, FL (US)

(72) Inventors: Latroy K. Randell, Deerfield Beach, FL (US); Tamicka B. Randell, Deerfield Beach, FL (US)

(21) Appl. No.: 14/991,459

(22) Filed: Jan. 8, 2016

Related U.S. Application Data
(60) Provisional application No. 62/101,228, filed on Jan. 8, 2015.

(51) Int. Cl. B26B 19/38; A45F 5/00

(52) U.S. Cl. CPC B26B 19/3813; A45F 5/00; A45F 2005/008

(57) ABSTRACT

A hair clipper guard holder is provided. The holder includes a base, a wrist strap, and a magnetic plate. The base includes a first side and a second side opposite the first side. The base further includes an upper surface and a lower surface. The wrist strap extends from the first side of the base and releasably secures to the second side of the base. The magnetic plate is secured to the base. At least one clipper, such as a plurality of clippers, includes a magnetic material that is attracted to the magnetic plate.

### BACKGROUND OF THE INVENTION

The present invention relates to hair clippers and, more particularly, to a magnetic hair clipper guard holder.

Hair clippers are specialized implements used to cut human head hair. They work on the same principle as scissors, but are distinct from scissors themselves and razors. Manual hair clippers are operated by a pair of handles which are alternately squeezed together and released. Barbers use them to cut hair close and fast. Electric hair clippers work in the same way as manual ones, but are driven by an electric motor which makes the blades oscillate from side to side. Clipper guards may be attached to hair clippers in order to cut hair at longer lengths. The guard will cut at the numbered guard length when the taper lever is in the shortest cutting position. Clipper guards are also known as clipper guide combs. Currently, clipper guards are stored in drawers at barber shops. When a barber needs to use a different guard, the barber must turn around and search for the correct guard to use.

As can be seen, there is a need for an apparatus that allows barbers to have immediate access to clipper guards.

### SUMMARY OF THE INVENTION

In one aspect of the present invention, an apparatus comprises: a base comprising a first side, a second side opposite the first side, an upper surface and a lower surface; a wrist strap extending from the first side and releasably securable to the second side; a magnetic plate secured to the base; and at least one clipper guard comprising a magnetic material attracted to the magnetic plate.

In another aspect of the present invention, a method of securing a clipper guard to a user comprises: providing a wrist strap comprising a magnetic plate; securing the wrist strap to a wrist of the user; and attaching at least one magnetic clipper guard to the magnetic plate.

In another aspect of the present invention, an apparatus comprises: an apparel comprising an inner surface and an outer surface, wherein the apparel is configured to be worn by a user; a magnetic plate comprising an upper surface, a lower surface, a length and a width, wherein a first side edge and a second side edge run along the length of the magnetic plate, wherein the lower surface of the magnetic plate is secured to the outer surface of the apparel; and a first ridge and a second ridge protruding from an upper surface of the magnetic plate, wherein the first ridge runs along the first side edge and the second ridge runs along the second side edge, wherein the first ridge and the second ridge form a receptacle in between; and at least one clipper guard comprising a magnetic material attracted to the magnetic plate.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is an exploded view of an embodiment of the present invention;

FIG. 4 is a section detail view of an embodiment of the present invention along line 4-4 in FIG. 1;

FIG. 5 is an exploded view of an alternate embodiment of the present invention; and

FIG. 6 is a perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

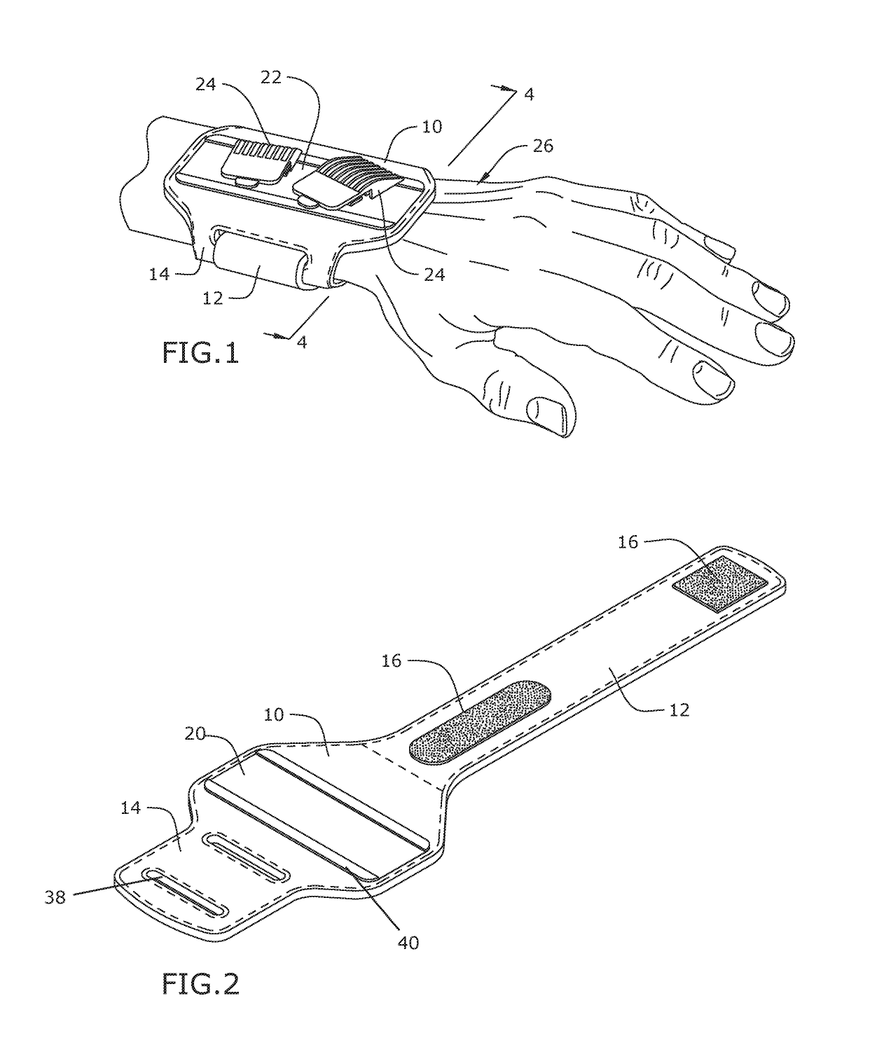

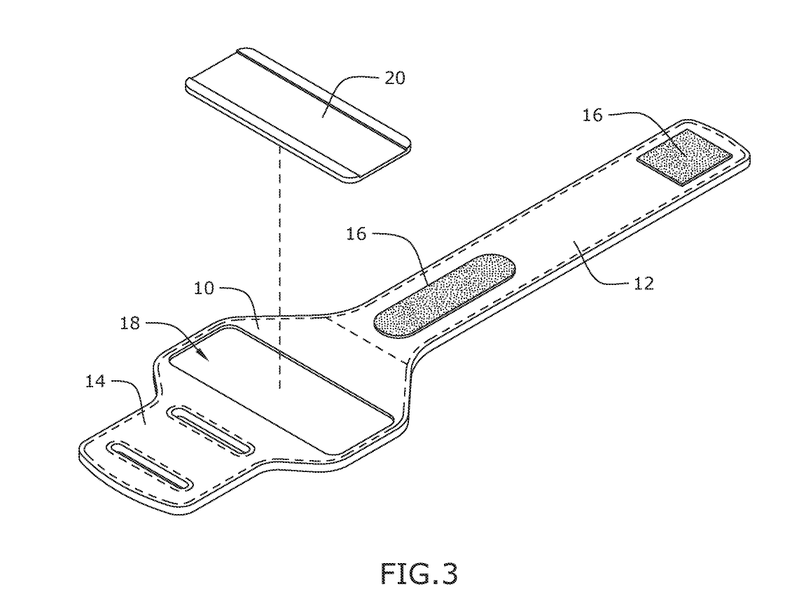

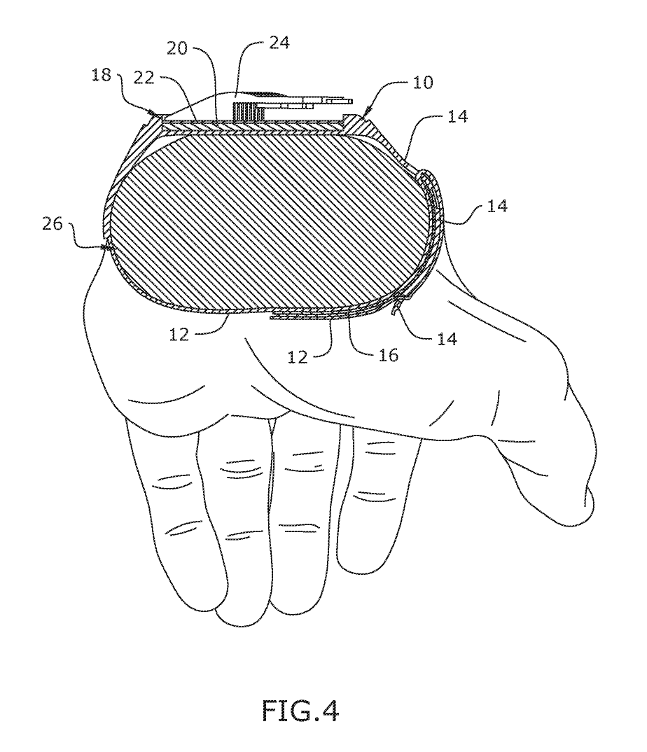

Referring to FIGS. 1 through 6, the present invention includes a hair clipper guard holder. Broadly, the holder includes a base 10, a wrist strap 12, and a magnetic plate 20. The base 10 includes a first side and a second side opposite the first side. The base 10 further includes an upper surface and a lower surface. The wrist strap 12 extends from the first side of the base 10 and releasably secures to the second side of the base 10. The magnetic plate 20 is secured to the base 10. For example, the magnetic plate 20 is secured to the upper surface of the base 10. At least one clipper guard 24, such as a plurality of clipper guards 24, includes a magnetic material that is attracted to the magnetic plate 20.

In certain embodiments, the present invention may be used with apparel such as the wrist strap mentioned above, a barber's apron, a barbers jacket, and the like. The apparel is configured to be worn by a user. The magnetic plate 20 includes an upper surface, a lower surface, a length and a width. A first side edge and a second side edge run along the length of the magnetic plate 20. The lower surface of the magnetic plate 20 is secured to the outer surface of the apparel.

The wrist strap 20 may releasably secured to the second side of the base 10 using different types of connectors. For example, the second side may include an extension 14 with at least one slot 38 formed therethrough. In certain embodiments, the extension 14 may include two or more slots 38. The wrist strap 12 includes a proximal end attached to the base 10 and a distal end. A first connector 16 may be attached to the upper surface of the wrist strap 12 on the proximal end and a second connector 16 may be attached to the upper surface of the wrist strap 12 on the distal end. The wrist strap 12 is wrapped around the user's wrist, and inserted into the slot 38. The first connector 16 is then secured to the second connector 16, thereby securing the wrist strap 12 to the user. The first and second connectors 16 may include, but is not limited to, hook and loop fasteners, snap buttons, clips, ties and the like.

In certain embodiments, the present invention may include a coating 22 on the upper surface of the magnetic plate 20. The coating 22 of the present invention may be a polymer coating, such as a rubber coating. The coating 22 of the present invention prevents damage to the magnetic plate 20 and the clipper guards 24.

The clipper guards 24 of the present invention may include an end having a clip portion. The clip portion is releasably attachable to the shearing portion of the clippers. The clipper guards 24 further include a plurality of teeth forming a comb extending from the clip portion. The clipper guards 24 may be made of a magnets or a metal that is attracted to magnets, such as a ferromagnetic material. Alternatively, the clipper guards may be made of plastic with an embedded magnet or ferromagnetic material that is attracted to the magnetic plate 20.

The magnetic plate 20 may be made of magnets. The magnetic plate 20 of the present invention may further include a first ridge 40 and a second ridge 40. The first ridge 40 and the second ridge 40 may extend from an upper surface along a length of the magnetic plate 20 on opposing sides forming a receptacle in between. The first and second ridge 40 guides a barber to the magnetic portion of the hair clipper guard holder. Therefore, the barber may quickly place the clipper guards 24 on the hair clipper guard holder without the need to look at the clipper guard holder.

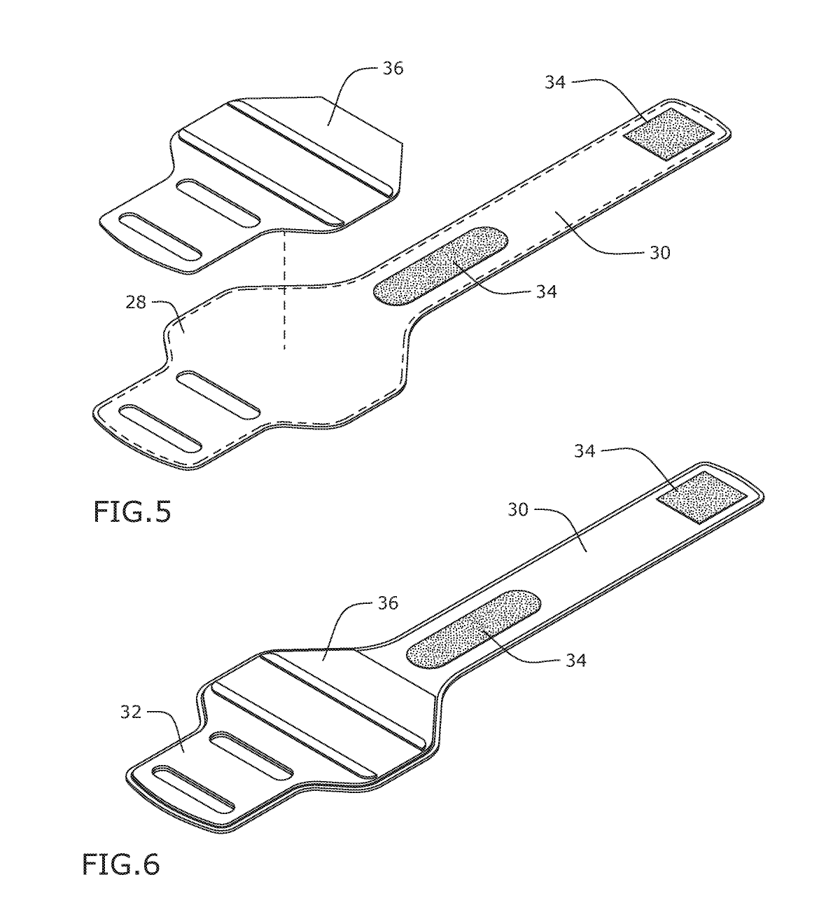

The present invention may include alternate embodiments. As illustrated in FIGS. 5 and 6, the present invention includes a base 28 with slots 38 formed on the extension 32 of the second side. A strap 30 having connectors 34 extends from the first side of the base 28 and is sized to fit within the slots 38. The magnetic plate 36 may be enlarged as compared to other embodiments. The magnetic plate 36 may cover the base 28 and extend to cover the extension 32. In such embodiments, the magnetic plate 36 may include a plurality of slots 38 that align with the plurality of slots 38 formed through the extension 32. Extending the magnetic plate 36 provides additional surface area for the clipper guards 24 to attach.

A method of using the present invention may include the following. The lower surface of the base 10 is placed on the wrist 26 of the user. The wrist strap 12 is wrapped around the wrist 26 and inserted into the slot 38. The wrist strap 12 is them pulled through the slot 38 to snuggly secured to the wrist 26. The first connector 16 is then secured to the second connector 16, thereby securing the clipper guard holder to the wrist 26. At least one clipper guard 24 is then magnetically attached to the magnetic plate 20. The barber may then quickly grab an alternative clipper guard 24 from the clipper guard holder when needed.

It should be understood, of course, that the foregoing relates to exemplary embodiments of the invention and that modifications may be made without departing from the spirit and scope of the invention as set forth in the following claims.

What is claimed is:

1. An apparatus comprising:
a base comprising a first side, a second side opposite the first side, an upper surface and a lower surface;
a wrist strap extending from the first side and releasably secures to the second side;
a magnetic plate secured to the base; and
at least one clipper guard comprising a magnetic material attracted to the magnetic plate.

2. The apparatus of claim 1, wherein the magnetic plate is secured to the upper surface of the base.

3. The apparatus of claim 1, wherein the second side comprises a slot sized to receive the wrist strap.

4. The apparatus of claim 3, further comprising a first connecter and a second connector releasably attachable to the first connector, wherein the first connector and the second connector are secured to an upper surface of the wrist strap.

5. The apparatus of claim 4, wherein the first connector and the second connector are a hook and loop fastener.

6. The apparatus of claim 1, further comprising a polymer layer disposed on an upper surface of magnetic plate.

7. The apparatus of claim 6, wherein the polymer layer is a rubber.

8. The apparatus of claim 1, further comprising a first ridge and a second ridge protruding from an upper surface of the magnetic plate and forming a receptacle in between.

9. A method of securing a clipper guard to a user comprising:
providing a wrist strap comprising a magnetic plate;
securing the wrist strap to a wrist of the user; and
attaching at least one magnetic clipper guard to the magnetic plate.

10. The method of claim 9, further comprising the step of:
wrapping the wrist strap around the wrist of the user;
inserting the wrist strap into a slot formed through the wrist strap; and
attaching the wrist strap to itself using a hook and loop fastener.

11. An apparatus comprising:
an apparel comprising an inner surface and an outer surface, wherein the apparel is configured to be worn by a user;
a magnetic plate comprising an upper surface, a lower surface, a length and a width, wherein a first side edge and a second side edge run along the length of the magnetic plate, wherein the lower surface of the magnetic plate is secured to the outer surface of the apparel; and
a first ridge and a second ridge protruding from an upper surface of the magnetic plate, wherein the first ridge runs along the first side edge and the second ridge runs along the second side edge, wherein the first ridge and the second ridge form a receptacle in between; and
at least one clipper guard comprising a magnetic material attracted to the magnetic plate.

12. The apparatus of claim 11, further comprising a polymer layer disposed on an upper surface of magnetic plate.

13. The apparatus of claim 12, wherein the polymer layer is a rubber.
